(19) United States
(12) Patent Application Publication
(10) Pub. No.: US 2003/0024636 A1
(43) Pub. Date: Feb. 6, 2003

(54) Method of manufacturing anti-counterfeit card label

(76) Inventor: Andy Lin, Taipei Hsien (TW)

Correspondence Address: Keith Kline, PRO-TECHTOR INTERNATIONAL SERVICES, 20775 Norada Court, Saratoga, CA, 95070-3018, US

(21) Appl. No.: 09/908,079

(22) Filed: Jul. 17, 2001

(51) Int. Cl. B32B 31/00; B42D 15/00; B42D 15/10

(52) U.S. Cl. 156/277; 283/72

(57) ABSTRACT

A method of manufacturing anti-counterfeit card label uses a man-made technical layer of unduplicated artificial sculpture in addition to the multiple-angle, multiple image reflective graphic display to constitute a totally unduplicable reflective whole graphics (which is known as 3D graphics), that can effectively generate the anti-counterfeit function. Furthermore, the present invention collaborates with the application of anti-tearing technology such that after the anti-counterfeit label is attached to the back of the card and is disposed between the middle layer of the card, it can prevent the anti-counterfeit label from being torn away from the card, and hence it ensures the card from any unauthorized or stolen use. The present invention increases the difficulty of counterfeiting, and further enhances the reliability of manufacturing the card. It is not only good for the card issuing company's business reputation, but it also lets the cardholder feel at ease to use the card, and enhances the security of using cards, which has a high commercial value.

### BACKGROUND OF THE INVENTION

1. Field of the Invention

The present invention relates to a method of manufacturing an anti-counterfeit card label, more particularly to a brand new graphic manufacturing method, which adds in man-made technical operations, and a multiple-angle multiple-image reflective whole graphic display to effectively increase the difficulty of counterfeiting. Meanwhile, the present invention collaborates with the implementation of anti-theft technology, and improves the reliability of the anti-counterfeit card label, and hence definitely enhances the security of using the card.

2. Description of the Prior Art

At present, the consuming behavior has entered into a mode of doing business transactions through credit cards, and this period is known as the plastic money era. Any monetary transaction or identification can be done by means of the records on the plastic card. Therefore the identity of the card, which directly relates to the user's right and the problem of counterfeit should be seriously considered. Particularly, the technology nowadays is improving day after day, and the duplication is not a difficult task anymore. It needs not to say and is commonly seen in the media that a plastic card can be duplicated easily. Counterfeits will damage our rights and even substantially impact the business order of the financial industry. However, it seems that card-issuing companies do not have good policies for anti-counterfeit design. Although some card companies have card label design with gold plated dot-matrix pictures on it, yet the duplication for those single pictured labels is not difficult at all; it only gives rise to difficulty on recognition but does not have an effective anti-counterfeit effect. Furthermore, even unauthorized people have not duplicated the card, but the pictured label can be taken away directly from the card for other illegal use. It makes the anti-counterfeiting more difficult for the card issuing company, thus it becomes a burden for the card user who is afraid of being ripped off. This situation has to be stopped and improved.

In view of the shortcomings of the prior art mentioned above, which are the subjects of improvements for a long time, hence the inventor of the present invention based on years of experience accumulated from the engagement in the related industry conducted extensive research to resolve the foregoing shortcomings and invented the present invention to provide a method of manufacturing an anti-counterfeit card label to improve the anti-counterfeit function for the cards and the security of using the card. The present invention also promotes proper financial transactions and the accuracy of the information transmission.

Therefore, the primary objective of the present invention is to increase the difficulty of the counterfeiting and improve the anti-counterfeit function by means of making a pictorial moldboard with artificial sculptured to produce a multiple-angle whole picture. The man-made art craft technology of the pictorial moldboard is just like the artwork, which only has one unique original. It is impossible to produce an identical pictorial moldboard, and hence increases the difficulty of making counterfeits and further improves the anti-counterfeiting function.

The secondary objective of the present invention is by means of a man-made sculpture pictorial moldboard and a multiple angle implementation to produce a whole picture so that we can see a 3D multiple-angle picture on the card label. Furthermore, by means of multiple-angle laser exposure technology, we can produce a plastic film of the reflective whole picture, and such plastic film collaborates with the manufacturing procedure such that it is securely mounted inside the structure of the plastic card. Such arrangement provides an effective way to set up the anti-counterfeit card label.

Another objective of the present invention is to provide an easy way of recognizing the original card by placing an anti-tearing seal on the plastic film of the anti-counterfeit card label, which is disposed inside the structure of the plastic card. If the anti-tearing label is taken out or transferred, the anti-tearing mark on the anti-counterfeit card label will show to identify the illegal or unauthorized use. It makes the card label to have the anti-theft effect, and hence to ensure an excellent security for using the card. Such arrangement has commercial value in the industry.

To make it easier for our examiner to understand the objective of the invention, structure, innovative features, and performance, we use a preferred embodiment together with the attached drawings for the detailed description of the invention.

### BRIEF DESCRIPTION OF THE DRAWINGS

Other objects, features, and advantages of the invention will become apparent from the following detailed description of the preferred but non-limiting embodiment. The description is made with reference to the accompanying drawings, in which:

FIG. 1 shows the flowchart of the method for manufacturing the card according to the present invention.

FIG. 2 shows the disassembled parts of the card of the present invention.

FIG. 3 shows the assembled card of the present invention.

FIG. 4 shows the application of the 3-D assembled card of the present invention.

### DESCRIPTION OF THE NUMBERING IN THE FIGURE

| | | | |
|---|---|---|---|
| 1 | Label manufacturing | 11 | Graphic moldboard |
| | procedure | | manufacturing process |
| 111 | Pattern board | 112 | Microscopic sculpture |
| 113 | Moldboard | 12 | Label formation manufacturing |
| | | | process |
| 121 | Multi-angle laser | 122 | Film |
| | exposure | | |
| 13 | Anti-theft process | 131 | Upper layer protective |
| | | | membrane |
| 132 | Upper anti-tearing seal | 133 | Adhesive glue |
| 2 | Card manufacturing | 21 | Front side of the card |
| | procedure | | |
| 22 | Back side of the card | 221 | Magnetic tape and label |
| 23 | Middle layer | 231 | Printing |
| 232 | Hole punching | 233 | Pressing |
| 234 | Sticking the anti- | 235 | Pressing |
| | counterfeit plastic plate | | |
| 3 | Cutting | 4 | Electroplated ring label |
| 5 | Seal | 6 | Complete production |
| A | Label | B | Hollow |
| C | Card | | |

### DESCRIPTION OF THE PREFERRED EMBODIMENT

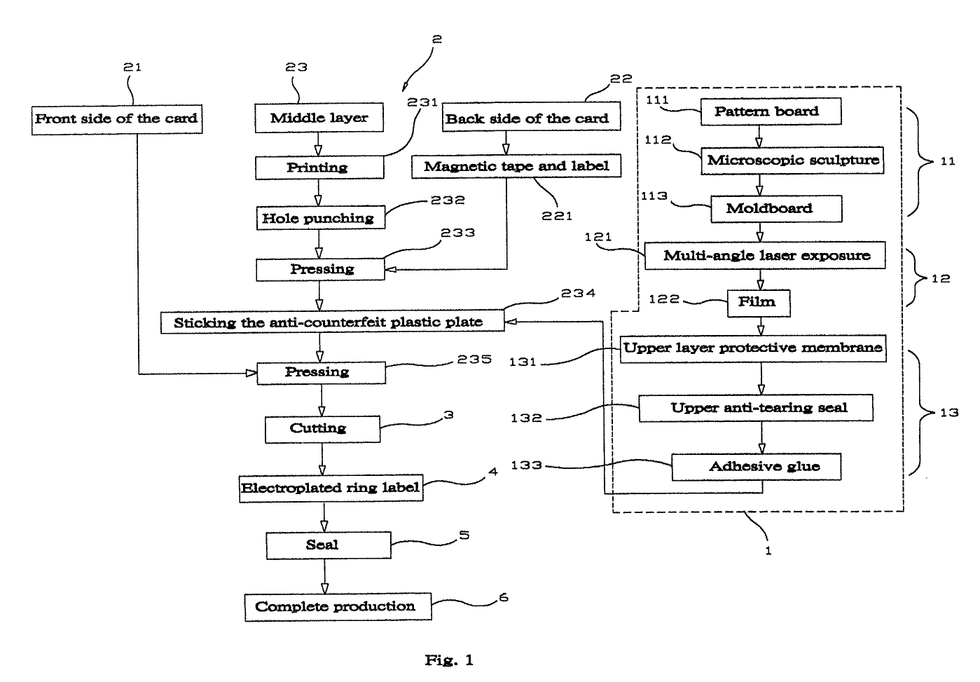

Please refer to FIG. 1, which shows the flowchart of the manufacturing method of the card according to the present invention, wherein the section enclosed by the dotted line is the manufacturing procedure (1) of the anti-counterfeit label (A) not shown in FIG. 1. The procedure comprises the manufacturing procedure of the pictorial moldboard process (11), and the label formation process (12) and the anti-tearing process (13). The production of pictorial moldboard includes the steps of selecting the pictorial pattern board (111), producing the moldboard by means of the artificial photolithographic sculpture technology and the multi-angle sculpture. Using the moldboard with the pictorial graphics, we can produce the reflective 3D whole picture (3D graphics). The 3D graphics is made of the multiple angled sculpture face, and show the lifelike three-dimensional picture; it shows different faces when viewing from different angles. The unique display effect of the whole picture label is not only easy to identify, but also improves the anti-counterfeit effect by the man-made art craft technology which has a high difficulty for the counterfeit. The manufactured moldboard (113) after the label formation process (12) and the multiple-angle laser photolithographic process (121), the whole picture of the moldboard (113) will show on the plastic film (122). After finished with the production of the operation of anti-tearing process (13), the film (122) is pressed with an upper protective membrane (131) and then pressed with an anti-tearing seal (132) on top of it for the anti-theft effect, and finally a Adhesive glue (133) is sealed to complete the finished product of the label (A).

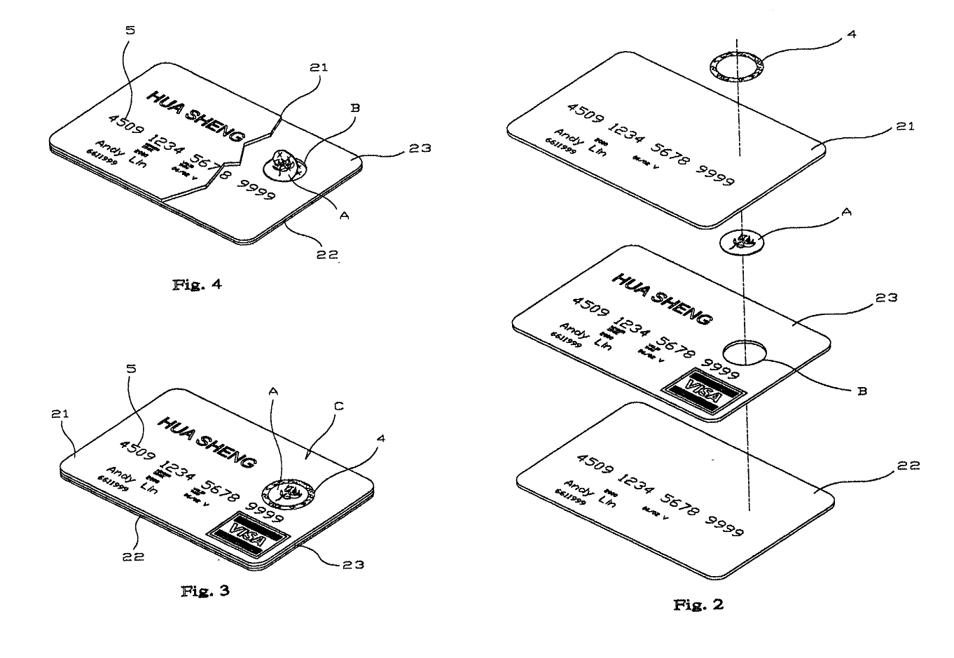

The finished product of the label (A) can work in line with the card manufacturing procedure as shown in FIG. 1, and the card manufacturing procedure (2) also comprises three sections: the front side (21) of the card, the back side (22) of the card, and the middle layer (23), wherein a magnetic tape and label (221) being stuck on the back side (22), and a pattern (231) being printed in the middle layer (23), and the label (A) being disposed at a predetermined position for the hole punch (232) operation, and then the back side (22) of the card being pressed for the positioning (233). The finished label (A) can then be pressed for positioning (233) with the back side of the card as shown in FIG. 2. A hollow (B) section is formed by means of the hole punching at the predetermined position of the label (A) in the middle layer (23) so that an anti-counterfeit plastic plate (234) of label (A) is disposed on the back side of the card (22). After completed with the sticking, the label (A) is pressed onto the front side (21) of the card such that the three sections (21, 22, and 23) will be combined to form the card body (C) and allow the label being disposed inside the structure of the card (C) as shown in FIG. 3. Finally, it proceeds with card cutting (3), ringed label electroplating (4), and sealing (5) for displaying the information on the card (C) to complete the whole manufacturing procedure of the card (C).

It is worthy to note that the production of the anti-tearing seal (132) enables the label (A) at the hollow (B) section in the middle layer to show a mark (marked as X in the figure) when the front side (21) of the card (C) is torn as shown in FIG. 4. It will show once for every tearing, and hence very easy to detect unauthorized and stolen use of the card by looking at the label (A). The label (A) has both anti-counterfeit and anti-theft effects on the application of the card (C), which is definitely effective for the anti-counterfeit function and has commercial value for the industry.

Furthermore, the method of manufacturing the card (C) according to the present invention can use some detecting equipment to test the real identity of the card in actual practice. We can visually inspect the electroplated ring label (4) on the card (C) at the preliminary stage. Since the electroplated ring label (4) is composed of symbols and the pattern is arranged according to the user's selection, the densely arranged pattern cannot be detected by visual inspection. Therefore, we can use the infrared reader for the recognition and by means of the infrared scanning on the electroplated ring label (4), we can test the symbols on the pattern and compare with our self-selected symbols to determine whether it is a real one or a counterfeit. In addition, the reflective whole graphics of the original moldboard saved in the computer can be used for the comparison, and the picture captured from the label (A) by a laser device is identified and compared one by one. It is very similar to the comparison of the signature, which gives an effective way for the identification. The present invention can be implemented with an anti-counterfeit function, which is definitely useful for the industry.

Therefore, in summation of the above description, the method of manufacturing anti-counterfeit card label according to the present invention is a new label manufacturing method of the graphic production technology. It effectively prevents counterfeiting, duplication, and theft, which gives a secure way for using the card. The method of manufacturing anti-counterfeit card is the research and development subject for enhancement. The inventor of the present invention based on years of experience in the related industry conducted extensive research to enhance the structure of the storage rack herein which is hereby submitted for patent application.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method of manufacturing anti-counterfeit card comprising a graphic moldboard process, label formation process, and anti-tearing process, wherein:
graphic moldboard process selects a graphic pattern for a pattern board, and sculpture a multi-angle pattern board for the moldboard by means of microscopic sculpture technology, and then produces an reflective whole 3D graphic moldboard;
label formation process uses the multi-angle laser exposure technology to display the whole graphic of the moldboard onto the film;
anti-tearing process presses an upper protective membrane onto the film, seals a anti-tearing seal, and finally presses a Adhesive glue on the back side of the film.

2. A method of manufacturing anti-counterfeit card as claimed in claim 1, wherein said card comprising a middle layer having a hollow section which is disposed at a predetermined position for accommodating the anti-counterfeit label and by means of the Adhesive glue of the anti-counterfeit label, the label is stuck on the back side of the card, and is disposed inside the structure of the card.
